(19) United States
(12) Patent Application Publication
(10) Pub. No.: US 2026/0227330 A1
(43) Pub. Date: Aug. 6, 2026

(54) APPARATUSES AND METHODS INVOLVING METADEVICES AND/OR PHOTONIC-BASED BIOSENSING

(71) Applicant: The Board of Trustees of the Leland Stanford Junior University, Stanford, CA (US)

(72) Inventors: Jack Hu, Stanford, CA (US); Jennifer A. Dionne, Menlo Park, CA (US); Fareeha Safir, Stanford, CA (US); Butrus T. Khuri-Yakub, Stanford, CA (US); Varun Dolia, Stanford, CA (US)

(21) Appl. No.: 19/128,031

(22) PCT Filed: Nov. 22, 2023
(86) PCT No.: PCT/US2023/080995

§ 371 Date: May 7, 2025

Related U.S. Application Data
(60) Provisional application No. 63/427,798, filed on Nov. 23, 2022.

(51) Int. Cl. G01N 21/552

(52) U.S. Cl. CPC G01N 21/554

(57) ABSTRACT

In one particular example, a molecular-analysis and diagnostic method involves an apparatus including a photonic mirror device having: outer opposing-end sections each including a set of one or more nanoblocks arranged to form a pre-tapering or padding section: a cavity section including differently-dimensioned interspersed nanoblocks of a length dimension d and of a perturbation dimension Ad; and situated between the opposing ends and the cavity section, first and second sets of three or more nanoblocks forming tapered sections (e.g., via a line that tracks with a polynomial-like function). At least the respective tapered sections and the cavity section cooperate to support guided-mode resonance for a metasurface pixel (“GMR pixel”) by containing light and optimally minimize energy losses due to scattering of light, in response to light being directed towards an optical sensor via the GMR pixel.

### BACKGROUND

Certain exemplary aspects of the present disclosure are related generally to the field of high throughput small-molecular analysis via optical sensing and/or optical sensing using metasurfaces (and metamaterials) in optically-related methods and apparatuses (e.g., systems and devices) including nanoantennas and in applications enabled by plasmonic and Mie-resonant (nanoantenna-like) structures.

Using one example application for ease of discussion, it has been appreciated that for the prediction, detection, monitoring, and treatment of organism and ecosystem health, nucleic acid, protein, small molecule and whole-pathogen tests are oftentimes deemed important. For example, respiratory panels identify antigen, antibody, nucleic acids, and whole-pathogen signatures indicative of infectious diseases like influenza and Coronavirus; nucleic acids and circulating tumor cells identify cancer and are used to guide treatment; and nucleic acids and small molecules found in environmental samples indicate the health of oceans, freshwater, livestock, soil and air. Most commonly, nucleic acid sequences are identified and profiled using techniques such as reverse-transcriptase polymerase chain reaction (RT-PCR), molecular beacons, and DNA microarrays; likewise, proteins and small molecules are detected using ELISA or lateral flow assays. For robust real-world applications, these techniques would ideally need to be optimized in terms of speed (high-throughput), sensitivity (e.g., RT-PCR, ELISA) and precision.

Some high-throughput small-molecular analysis may be realized via optical sensing involving metasurfaces in methods and apparatuses (e.g., systems and devices) including nanoantennas and in applications enabled by plasmonic and Mie-resonant (nanoantenna-like) structures. Dimensions of such nanoantennas, and cavities formed by such miniaturized optical structures, are subwavelength and they exhibit dipole-like point sources, which are especially useful for example in connection with far-field control/metasurfaces (among other technologies or applications).

For such small-molecular analysis, many methods have used high-quality-factor (high-Q) diffractive optical metasurfaces including nanoantenna arrays. The nanoantenna arrays are engineered to simultaneously trap and thus amplify light as well as manipulate the way light is scattered to the far-field. The trapping capability, which is key to sensing, is achieved by structuring individual antennas made from transparent, high refractive index materials such as silicon, so that they support guided mode resonances (GMR, as indicated by diffraction spectra showing a sharp dip at visible to near-infrared wavelengths). The lifetime of an optical resonance is characterized by the Quality factor (Q), measured by dividing the center frequency by its spectral width. In an ideal design, the GMR is used to trap light over an infinite number of optical cycles, producing an equivalent multiplication of the incident light intensity. The Q-factor corresponds to a measurement of physically tracking of the degree to which the circulating optical intensity within a resonator is enhanced relative to the excitation. Nanoantenna radiation losses can be quantified in terms of the Quality factor (Q-factor), which physically tracks the degree to which the circulating optical intensity within a resonator is enhanced relative to the excitation. Many dipolar nanoantennas have a Q of order 10, meaning that they leak light rapidly and therefore exhibit weak nearfield amplitudes.

While there has been significant research regarding such optical structures and their related optical properties and related advancements have resulted from this research, there is still much room for improvement towards an optimized real-world molecular analysis system, for example, in terms of optimizing higher throughput molecular analysis with greater accuracy by realizing even larger Q's and greater feature densities.

### SUMMARY OF VARIOUS ASPECTS AND EXAMPLES

Various examples/embodiments presented by the present disclosure are directed to issues such as those addressed above and/or others which may become apparent from the following disclosure. For example, some of these disclosed aspects are directed to methods and devices that use or leverage from nanophotonic-metasurface platforms and as applied in any of a variety of fields including, as examples, nanophotonic platforms, and in applications in fields spanning healthcare, point-of-care diagnosis, environmental monitoring, remote sensing, and imaging involving a wide variety of technologies.

In one specific example, a method involves use of an apparatus (e.g., device, subassembly, system, etc.) and/or such an apparatus itself, with the apparatus characterized as including a photonic mirror device having opposing ends respectively characterized by first and second sets of one or more nanoblocks forming pre-tapering sections, a cavity section including a plurality of differently-dimensioned interspersed nanoblocks having a length dimension d and a perturbation dimension Δd, and first and second sets, each of three or more nanoblocks, situated between the opposing ends and the cavity section, to form respective tapered sections. At least the respective tapered sections and the cavity section, in certain examples, are cooperatively arranged to support guided-mode resonance for a metasurface pixel (“GMR pixel”) by containing light and mitigating energy losses due to scattering of light, in response to light being directed towards an optical sensor via the GMR pixel.

In certain other examples which may also build on the above-discussed aspects with features or characterizations of the photonic mirror device varying in terms of the degree in which to maximize the high-Q factors for the specific applications and methods, and in varying functional attributes and structural aspects of the photonic mirror device by varying the opposin_{g} ends, the tapered sections and the cavity section.

In yet more specific aspects, the above-characterized semiconductor structure are directed to aesthetic aspects of the design of the photonic mirror device, for example, as illustrated herein in FIG. 1.

The above discussion is not intended to describe each aspect, embodiment or every implementation of the present disclosure. The figures and detailed description that follow also exemplify various embodiments.

### BRIEF DESCRIPTION OF FIGURES

Various example embodiments, including experimental examples, may be more completely understood in consideration of the following detailed description in connection with the accompanying drawings, each in accordance with the present disclosure, in which:

FIG. 1 is a perspective view of an optical sensing system showing an expanded view of a finite pixel, according to certain exemplary aspects of the present disclosure;

FIG. 2A-2L are illustrations showing characteristics of exemplary aspects for the exemplary type of optical sensing embodiment shown in FIG. 1, according to the present disclosure, with: FIGS. 2A and 2D showing a simplified TE band diagrams for, respectively, an infinitely long photonic cavity with a mirror segment of certain dimensions and for another mirror segment, FIG. 2B showing electric field enhancements for a cavity section, FIG. 2C showing a graph of cavity length versus Q factor for different perturbations, FIG. 2E showing a graph of mirror strength calculated using band positions for mirror segments of different widths; FIGS. 2F and 2G showing optical characteristics for certain elongated high-Q photonic antennas (“VINPix” structures), FIG. 2H showing simulated Q-factors of 15-μm-long VINPix with a 5-μm-long cavity of different perturbations and 5-μm-long tapered mirrors sections of different polynomial orders, FIG. 2I showing simulated Q-factors of 15-μm-long VINPix with varying fractional configurations of the lengths of the cavity section, tapered mirrors sections and padding mirrors sections, FIG. 2J showing simulated normalized electric near-field enhancements of a VINPix with certain dimensions, FIG. 2K showing far-field simulation plot of an optimized VINPix, and FIG. 2L showing simulated electric near-field profile through the cavity of the optimized VINPix;

FIGS. 3A-3C are also according to certain exemplary aspects of the present disclosure, wherein FIG. 3A is a SEM image (top-down view) of a substrate (e.g., the metasurfaces of FIG. 1) with an array optical mirror elements, FIG. 3B shows a spectral image from five individual VINPix (left panel) and corresponding normalized row-averaged reflected intensities (right panel), and FIG. 3C shows experimentally-characterized Q-factors of different VINPix;

FIG. 4A shows another optical system according to the present disclosure, FIGS. 4B and 4C show related intensity-versus-wavelength plots, FIGS. 4D and 4E show related spectral responses as in the left and right panels of FIG. 4E, and FIG. 4F is a grid-based graph showing the resonance shift mapping versus wavelength for each pixel-treated substance; and

FIGS. 5A-5F illustrate examples of multiplexed sensing of distinct antigens/antibodies using high-Q metasurfaces and bioprinting consistent with one or more sensing systems according to the present disclosure, with: FIG. 5A showing functionalization of a VINPix on a Si metasurfaces via bioprinting of an antigen specific to one of several antibodies, FIGS. 5B and 5E showing plots of resonance shifting for each of the several antibodies, FIG. 5D showing intensity-versus-wavelength plots for each of the several antibodies, and FIGS. 5C and 5F depict different VINPix being functionalized for different types of antigens/antibodies.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

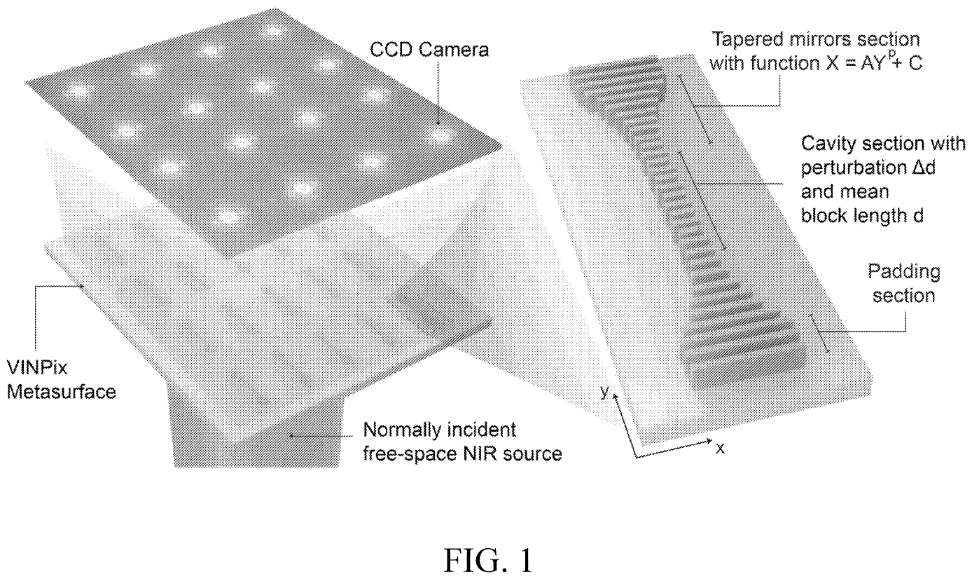

Aspects of the present disclosure are believed to be applicable to a variety of different types of apparatuses and methods characterized at least in part by arrangements including high-Q diffractive metasurface platforms including nanoantenna arrays configured to manipulate light via the metasurface and towards a sensor (e.g., a charge-coupled device (CCD) or CMOS sensor(s)) having an array of printed sensor pixels with photonic mirror elements optimized to suppress light leakage for molecule sensing via high-Q diffractive optical metasurfaces. In certain specific experimental example embodiments (e.g., consistent with FIG. 1), aspects of the present disclosure are highlighted with reference to a metasurface including high-Q photonic antennas (GMR Pixels, which are 15 μm in length and which are individually addressable), and based on a GMR Pixel design that has three distinct sections: a photonic cavity section, a tapered mirrors section, and a padding mirrors section. Via these sections, this design is able to manipulate free-space light into subwavelength volumes while still maintaining a high Q-factor and a controlled dipolar response to the far-field, and this can be used for widefield imaging of hundreds to thousands of devices simultaneously. While the present disclosure is not necessarily limited to such aspects, an understanding of specific examples in the following description may be understood from discussion in such specific contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

More particular exemplary embodiments are directed to arrangements including high-Q diffractive metasurface platforms including nanoantenna arrays configured to manipulate light via the metasurface and towards a sensor (e.g., CCD)) having an array of printed sensor pixels with photonic mirror elements optimized to suppress light leakage for molecule sensing via high-Q diffractive optical metasurfaces. In addition to compressing this light over time, the metasurface in this above type of arrangement also squeezes light into a very small volume. Taken together these effects result in a substrate whose scattering responds very sensitively to the presence of antigen nucleic acid fragments and antibodies. In view of this sensitivity and particularly for nanoantenna arrays engineered to trap, amplify and manipulate the way light is scattered to the far-field, another important property of the optical resonances concerns the optical mode volume (aka “mode volume” or Vₘ) associated with the light-confining cavity. Specifically, the mode volume refers to a measure of the spatial confinement of electromagnetic radiation inside the cavity.

With both Q factor and mode volume playing important roles in characterizing the optical resonance, efforts implemented according to the present disclosure have given consideration to how these factors interrelate. For example, for strong cavity effects, one may consider pursuing a higher Q factor and a larger or smaller mode volume (or high V), depending on how the optical structures may come into play (e.g., metasurfaces) and affect the mode volume and, in some instances (e.g., photonic crystal ring resonators and ring resonator devices), strong cavity effects may be realized by a high Q factor and a high V. For many applications such as those involving metasurfaces, high Q-factors and/or small mode volumes can be important for eliciting certain of the desired optical properties.

In connection with certain aspects and efforts leading to the present disclosure, research has been directed to understanding whether there are any key relationships between high Q-factors and small mode volumes (as in antenna size). For example, in connection with such efforts leading to the present disclosure, research has been directed to addressing whether there is a fundamental tradeoff between antenna size in relation to wavelength and optical resonant lifetime (characterized by the Quality factor (Q). This research has led to certain exemplary aspects of the present disclosure and the unexpected discovery that with respect to antenna size in relation to wavelength and resonant lifetime, the tradeoff between Q and mode volume is, in fact, not fundamental. In this regard, exemplary experimental embodiments according to the present disclosure have achieved simultaneously high Q and small V, thereby significantly boosting Q/V. In connection therewith, such efforts have experimentally demonstrated that dipolar GMRs can be excellent high-Q substitutes for Mie resonators in phase gradient metasurfaces, and that this may be applied for use in high-Q lensing, EO (electro-optic) beam steering, and molecular-level sensing (due to semi-infinite extension of each GMR bar, structures were only subwavelength in one dimension).

Accordingly, exemplary aspects of the present disclosure are related to such arrangements, and their methods of use, involving a photonic mirror device having certain characteristics which have been discovered as being useful to optimize the ability to capture light while suppressing light leakage for molecule sensing via high-Q diffractive optical metasurfaces. In one specific type of example according to the present disclosure, such a photonic mirror device includes: opposing ends respectively characterized by first and second sets of one or more nanoblocks forming pre-tapering or padding sections; a cavity section including a plurality of differently-dimensioned interspersed nanoblocks having a length dimension d and a perturbation dimension Δd; and first and second sets, each of three or more nanoblocks, situated between the opposing ends and the cavity section, to form respective tapered sections. The respective tapered sections and the cavity section are cooperatively arranged to support guided-mode resonance for a metasurface pixel (“GMR pixel”) by containing light and mitigating energy losses due to scattering of light, in response to light being directed towards an optical sensor via the GMR pixel, and in more particular embodiments, the tapered sections and the cavity section (e.g., with or without the nanoblocks of the opposing ends) are designed with respective dimensions and spacings between the dispersed nanoblocks to maximize the Q factor.

Such optimization or maximization of the Q factor can be largely realized with or without special configuration of the opposing ends. However, in certain experimental examples, particular embodiments have realized an approximately-maximized Q factor by implementing the configuration of the nanoblocks in each of the opposing ends, for example, by designing the nanoblocks to have a length dimension that is greater than any length dimension characterizing respective nanoblocks of the cavity section (and/or of tapered sections). Also, the nanoblocks may be designed to have a length dimension that is common or similar to each nanoblock of each opposing end (while in some example embodiments, the length dimension is common only at one of the opposing ends).

Further and as is apparent from certain experimental example embodiments illustrated herein, each of the opposing ends includes three nanoblocks, with each of the three nanoblocks having a common or similar length dimension that is not less than a length dimension of any other nanoblock of the photonic mirror device.

Each of the respective tapered sections may also be characterized by decreasing block lengths of respective nanoblocks, from among the three or more nanoblocks along a direction towards the cavity section. The range in terms of the number of nanoblocks is preferably from three to several nanoblocks depending on the specific application and related factors such as pixel-size constraints, and ideal degree to which maximizing the Q factor is needed, etc.

In connection with more-particular example embodiments which build on the above-characterized aspects, such more-particular embodiments may implement features (or aspects) of the photonic mirror device according to one or any combination of two or more of the following. As a first example, the opposing ends with sets of one or more nanoblocks forming pre-tapering or padding sections are to mitigate photons scattering from the opposing ends, and the respective tapered sections are to have at least one side of decreasing block lengths in a direction towards the cavity section (e.g., with a polynomial-like characterization such as by X=AY^{P}+C, where X defines the block length from among the decreasing block lengths, and A, Y, P and C represent respective positive numbers).

Also building on the above-described aspects and depending on the specific application, more-particular example embodiments may permit for variation of the differently-dimensioned interspersed nanoblocks of the cavity section. For example, in certain experimental efforts more-detailed embodiments realized the cavity section using at least five nanoblocks characterized as having length dimension “d” and at least five nanoblocks having a perturbation dimension Δd (e.g., length dimension “d” offset by a certain amount). For example, this perturbation dimension may refer to a single amount of offset in length relative to length dimension “d” or may refer to an average amount of offset in length relative to length dimension “d”. Further, in certain specific examples, the number of nanoblocks characterized as having length dimension “d” and/or the number of nanoblocks associated with perturbation dimension Δd may be as few as three and as many as a dozen (again, depending on the specific applications).

Further, the skilled artisan will appreciate that the differently-dimensioned interspersed nanoblocks of the cavity section may be interspersed in various ways. As in certain examples illustrated herein such nanoblocks are interspersed in an alternating context, with each sequentially-positioned one of the nanoblocks of the cavity section being characterized as changing from having length dimension “d” to one of the nanoblocks associated with the (e.g., average or exact) perturbation dimension Δd. In other specific examples, such nanoblocks are interspersed in a different alternating context, for examples, wherein sequentially-positioned ones of the nanoblocks of the cavity section are characterized as changing from one, two or three sequentially-positioned nanoblocks having length dimension “d” to one, two or three sequentially-positioned nanoblocks being associated with the (e.g., average or exact) perturbation dimension Δd.

In connection with certain experimental embodiments realizing minimal leakage and maximum Q factor, the nanoblocks of each of the above-noted sections, including the cavity section, are configured (e.g., positioned, sized and spaced) to support GMR and to confine light and mitigation energy losses due to scattering of light, in response to light being directed towards the GMR pixel. In certain examples, the light is to be confined with mitigation of energy losses via the tapered section characterized by a tapering slope corresponding to an order 4 polynomial function.

Consistent with the above exemplary aspects, such an apparatus (e.g., including the above-characterized sections of the photon mirror device) may be a (high-Q molecular-analysis) system which has other components cooperating with the photon mirror device. In one example, such a system includes two or more aspects or features from among the following: a metasurface substrate to support a plurality of such GMR pixels including the above-type of GMR pixel, wherein each of the plurality of GMR pixels is similarly constructed; a light source (chip-integrated laser and/or optic elements such as a mirror) to present (e.g., direct) the light for the guided-mode resonance and scattering via the metasurface substrate; a CCD sensor as the optical sensor to capture the light being directed via the GMR pixel; and a computing data processor to address and select individual pixels associated with the CCD sensor to process the captured data (e.g., for analysis and recognition of particular targets (e.g., antigens/antibodies) relative to the functionalized portions of the metasurface substrate). In certain instances, the system includes the metasurface substrate having an array of such GMR pixels including the GMR pixel, each of the GMR pixels including the GMR pixel being a bio-functionalized pixel characterized by an attachment of distinct receptor or probe molecules to the GMR pixel.

Consistent with the above aspects, such a manufactured device or method of such manufacture may involve aspects presented and claimed in U.S. Provisional Application Ser. No. 63/427,798 filed on Nov. 23, 2022 (STFD.447P1) with Appendices, to which priority is claimed. For other background regarding such optical metasurfaces molecular analysis structures and their related optical properties, reference may be made to previous documents cited as WIPO Publ, No. 2022076832 (“Resonant Nanophotonic Biosensors”), and U.S. Pat. No. 11,391,866 (“High quality factor non-uniform metasurfaces.” issued Jul. 19, 2022), both involving experimental platforms for high throughput molecular analysis through which free space illuminated resonators are realized with high-Q resonances in physiological/patterned media (e.g., over 2,200), tuned, and measured at high densities (e.g., >100,00 (and in some examples over 160,000) pixels per cm²). To the extent permitted, such subject matter is incorporated by reference in its entirety generally and to the extent that further aspects and examples (such as experimental and/or more-detailed embodiments) may be useful to supplement and/or clarify aspects of the present disclosure.

In more particular examples, experimental embodiments according to the present disclosure are implemented to attain very high Q/V responses (or optimal insofar as difference with the ideal are negligible for the application such as in small-molecule health diagnostics). As discussed below in connection with the example system illustrated in FIG. 1 according to the present disclosure, these experimental embodiments include certain designs having one-dimensional nanobeam cavities which are advantageous due to their inherently small footprints, high Q-factors, and compatibility with contemporary fabrication technologies. For instance, while previously-implemented efforts involving one-dimensional photonic crystal cavities that take advantage of Bragg mirrors have reported Q-factors larger than a few hundreds of thousands in experiments and mode volumes as low as 0.5 (λ/n)³, certain experimental embodiments according to the present disclosure have realized Q-factors in the range from 1000 to 5000 (e.g., as approximated) and mode volumes (e.g., theoretical) as low as 0.1 (λ/n)³. However, as such previous photonic crystal cavity designs rely on optical fibers to couple into the modes of interest (which decreases the coupling efficiency and is a hurdle towards convenient deployment of these platforms for many applications), such experimental embodiments according to the present disclosure have realized an easily-addressable, dense-metasurface design with features supporting modes having high QN values (e.g., approximately 25,000 in simulations.

Turning to the drawing and consistent with the present disclosure, FIG. 1 is a perspective view of an optical sensing system showing an expanded view of a finite pixel, according to certain exemplary aspects of the present disclosure. A dense metasurface with individually addressable 15 ums-long high-Q photonic antennas (sometimes referred to as “VINPix” in singular and plural, or as Finite Pixels or “FinPix”) are composed of Si nanoblocks on a sapphire substrate. The resonances can be excited using a normally incident near-infrared (NIR) laser source and the signal can be recorded on a spectrometer or a CCD camera. This exemplary VINPix structural design is shown having: a nanophotonic cavity section in the center (e.g., to support high-Q guided mode resonances), tapered mirror sections leading to the nanophotonic cavity section, and padded (or padding) mirror sections at opposing ends.

Relative to previously-reported efforts (e.g., Hu, Jack, et al. “Rapid genetic screening with high quality factor metasurfaces” (preprint), 2021) involving one-dimensional waveguide nanocavities, experimental example embodiments as exemplified herein by FIG. 1 implement sets of photonic crystal mirrors as a photonic mirror device, situated on or against such a metasurface-based substrate (e.g., each VINPix in the four-by-four array), to shrink their lengths drastically without compromising on their Q-factors. Each VinPix is individually addressable and supports high-Q guided mode resonances that could be conveniently excited through normally incident light, as depicted in FIG. 1. Still referring to FIG. 1, the (nanophotonic) cavity section may include nanoblocks with a periodic perturbation to excite modes of interest through free-space illumination, the tapered mirror section is configured to minimize the undesired out-of-plane scattering, and the pre-tapering (or padding) mirror section is configured to increase the strength at which the modes are confined. In one experimental example consistent with depictions of the photonic mirror device shown in FIG. 1, a 15 um long VinPix with a perturbation of 50 nm has been demonstrated as being capable of sustaining GMRs with a Q-factor in a range from a few to several thousand at the low end and well over ten thousand at the upper end (and in some instances with a Q-factor of approximately 12,000) in simulations. Moreover, such experimentation has shown (e.g., through simulations) that such realized Q-factor can be manipulated by changing the perturbation magnitudes of the nanoblocks interspersed in the cavity section (e.g., easily boosted by decreasing the perturbation magnitude of the length dimension of the nanoblocks in the cavity section). As shown in other ones of the figures herein, these experimental examples and realizations have been demonstrated by way of fabricated designs (e.g., corresponding to FIG. 1 and variations thereof as discussed herein) for use in hyper-spectral imaging for refractive index-based multiplexed sensing applications.

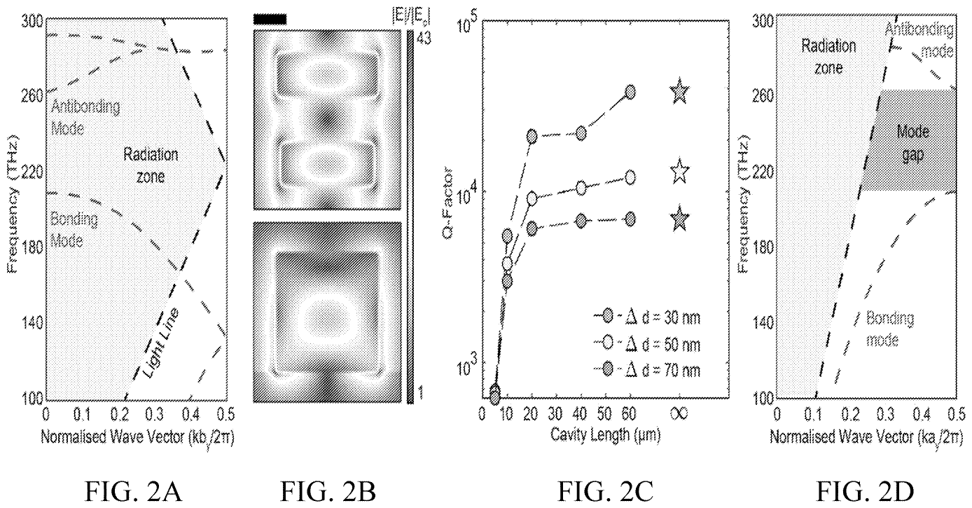

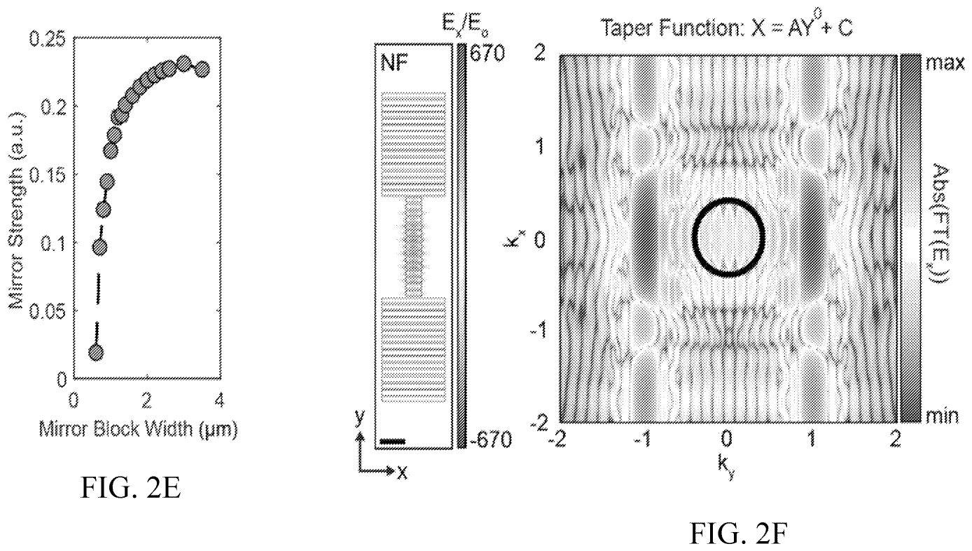

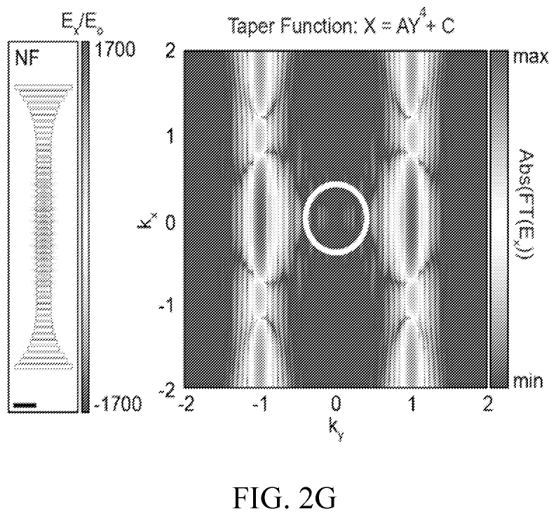

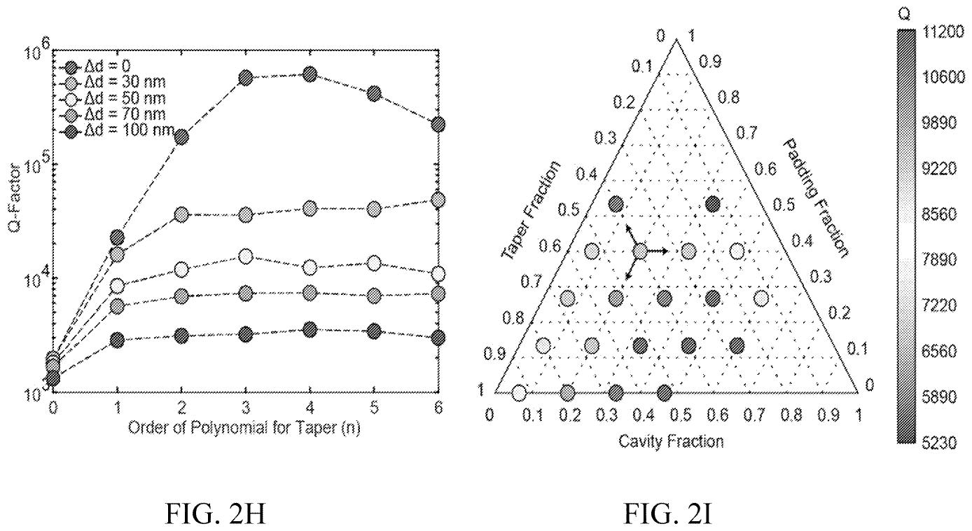

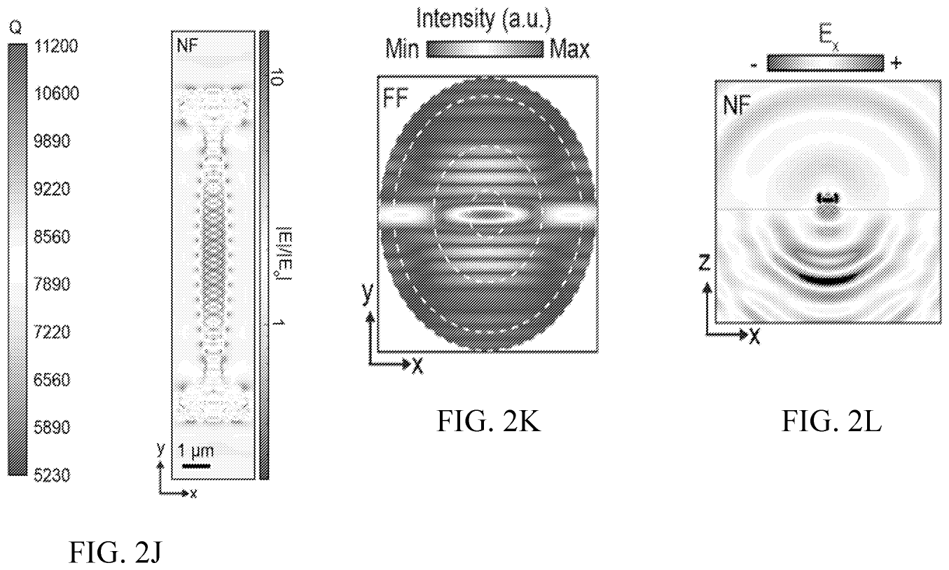

FIGS. 2A-2L are illustrations showing exemplary features and performance characteristics, according to the present disclosure, for the example type of optical sensing embodiment depicted in FIG. 1 and with a common exemplary VinPix design with the distinct sections as described above. Generally, these illustrations include simplified TE band diagrams (FIGS. 2A and 2D) showing the guided mode resonances supported by the photonic cavity. This component underpins the antenna's impressive capability to couple and resonate free-space light into the device with (e.g., bi-periodic) perturbations present in the cavity section of the design. A surprising discovery and significant breakthrough lies in overcoming the conventional trade-off between device size and performance. To achieve high Q-factors without excessively extending the device footprint, such a design according to the present disclosure reduces to practice integrated tapered photonic crystals into the cavity design, thereby strategically enabling compact yet highly-efficient devices. Through significant research involving meticulous adjusting of the taper polynomial and the fractional configurations of the cavity and mirror sections (e.g., FIGS. 2H 2I), a Gaussian-like field profile within the antenna is achieved, and this profile plays a substantive role in minimizing out-of-plane scattering (which is a challenge often encountered in photonic devices but elegantly addressed here with the demonstration of high-temporal enhancements). Consequently, this type of design provides a high spatio-temporal enhancement of light, maintained within a remarkably compact structure. Moreover, this type of design still facilitates the radiation of light in a dipolar fashion (FIGS. 2K and 2L), balancing efficiency with functionality. Also important to note is that this type of design surprisingly evidences that size and performance are no longer inversely related, marking a significant step forward (relative to the above-referenced previous documents) in free-space photonic technology.

Now turning to the particular example of the general type of design used in such successful experimentation and realizations, one non-limiting exemplary embodiment uses as a VinPix, 600-nm-tall nanoblocks of silicon on a sapphire substrate (as may be implemented via any of differently-sized arrays with one such VinPix at each point of the array), and with the nanoblocks of different length dimensions (e.g., “d”=600 nm and “Δd”=50 nm, with the unit cell size or periodicity (by)=660 nm) interspersed in an alternated manner. The bonding and antibonding guided mode resonances of interest can be excited at selected frequencies, for example, bands at 207 THz and 262 THz (for k_{∥}=0) as exemplary bonding and anti-bonding guided mode resonances of interest. Certain of these characteristics are indicted in the simplified TE band diagram of FIG. 2A (for an infinitely long photonic cavity with average width, d=600 nm and Δd=50 nm), with FIG. 2B showing simulated normalized electric field enhancements at the cross-section of the unit cell of an infinitely long cavity with Δd=50 nm, of the bonding guided mode resonance (GMR). Geometrical parameters of the resonator unit cell are: height=600 nm, average width (d)=600 nm, thickness (t)=160 nm, block spacing (a_{y})=330 nm. Scale bar 200 nm. FIG. 2C shows simulated Q-factors of the GMR for waveguide cavities of different lengths, wherein the stars correspond to waveguide cavities of infinite length with the upper plot for Δd=30 nm, the middle plot for Δd=50 nm and the lower plot for Δd=70 nm. FIG. 2D is a simplified TE band diagram for a mirror segment with d=600 nm with labeled sections of the diagram including radiation or leaky zone, the bonding and anti-bonding guided mode resonances of interest respectively in the upper right and lower right corners of the diagram, and also the corresponding mode gap. FIG. 2E plots the mirror strength calculated using band positions for mirror segments of different exemplary widths. Supplementary Figures in the above-referenced U.S. Provisional Application may be referenced for further detailed disclosure regarding certain of the above characteristics.

FIGS. 2F and 2G are included to help show the importance of certain aspects of the present disclosure. These figures depict simulated cross-sectional field profiles for the x-component of the electric field and corresponding Fourier transform spectra on a logarithmic scale to visualize the out-of-plane scattering for a VINPix with Δd=0, with a tapered mirrors section of orders, p=0 (FIG. 2F, for the taper (polynomial-like) function characterized as AY^{P}+C) and p=4 (FIG. 2G and as shown in FIG. 1, for the same taper (polynomial-like) function). The region inside the circle for each of the profiles is the radiation zone. Nanoblocks are marked with black borders in the cross-sectional field profiles to aid visualization. The depicted scale bar for the structures of FIGS. 2F and 2G is 1 μm.

In certain of these experimental examples (each being successfully implemented), the nanoblocks used in the photonic mirror devices are of similar thickness and an interblock distance (“a”, between adjacent nanoblocks) is kept the same within all the sections to minimize any additional phase mis-match at the interface of the sections. In the tapered section, the length of the mirror segments (“d”) is gradually increased as the mirror section extends away from the cavity end, using different tapering functions. This is to create a Gaussian field profile along the length of the device for minimizing the out of plane scattering and strongly confining the mode of interest.

FIG. 2H shows simulated Q-factors of 15-μm-long VINPix with a 5-μm-long cavity of different perturbation magnitudes (from the highest Q-factor plots to the lowest: Δd=0, Δd=30 nm, Δd=50 nm, Δd=70 nm and Δd=100 nm,), and 5-μm-long tapered mirrors sections of different polynomial orders. The different perturbation magnitudes are shown in FIG. 2H from the highest Q-factor plots to the lowest as: Δd=0, Δd=30 nm, Δd=50 nm, Δd=70 nm, and Δd=100 nm.

FIG. 2I shows simulated Q-factors of 15-μm-long VINPix with varying fractional configurations of the lengths of the cavity section, tapered mirrors sections (p=4 for the above-noted function), and padding mirrors sections. The black arrows point towards the respective axes for one representative configuration having 0.2, 0.4 (combined, for both sides of the VINPix), and 0.4 (combined, for both sides of the VINPix) fractions of the VINPix's total length for each of the three sections respectively. If viewed in black and white, the grid locations of FIG. 2I show perturbation magnitudes as follows: Δd=0 for the top two points (above the 0.5 horizontal fraction) representing Q factor of ~5230; Δd=30 nm for the four points from the bottom left and upward along the <0.1 marking of the cavity fraction axis (as well as the one point on the right of the grid at the horizontal line indicated by 0.6 taper fraction) and representing a Q factor in the range of −6600-7890; Δd=1000 nm for the two sets of three points from the bottom left and upwardly to the right from the 0.3 and 0.4 markings (respectively for each of the two sets) of the cavity fraction axis and representing a Q factor in the range of ~10,000-11,200; and the remaining points representing Δd=50 nm and Δd=70 nm corresponding to a Q factor in the range of ~9000-9220.

FIG. 2J shows simulated normalized electric near-field enhancements at the cross-section of a VINPix with 7-μm-long cavity section of Δd=50 nm, 3-μm-long tapered mirrors sections of p=4 (same function as above) and 1-um-long padding sections on each end. FIGS. 2I and 2J are the same (Q factor at 11200 for showing an upper and highest intensity indication at the top of the scale and Q factor at 5230 for a lower and least intensity indication at the scale bottom).

FIG. 2K shows a far-field simulation plot of the optimized VINPix (e.g., with the far-field as depicted in FIG. 1). Concentric circles represent 10°, 30°, 60°, and 90° from the center respectively. The highest intensity indication is at the center and on the right of the depicted scale.

FIG. 2L shows simulated electric near-field profile through the cavity of the VINPix as optimized as indicated with these dimensions. The highest intensity indication is at the right of the depicted scale.

The perturbation is used as a channel for coupling light into and out of the VINPIX design, and it can be tuned to control the lifetime of the modes inside the device. Decreasing the magnitude of perturbation significantly increases the resonant lifetime of the modes, recorded in terms of Q-factors, and, as one example, can be over 100,000, over 200,000 and in some instances, as high as ~240,000, in simulations with a perturbation of 10 nm. Increased resonant lifetime of the modes is reflected in a strong electric near-field enhancement. For certain experimental examples, an enhancement of an order of magnitude or more (in some instances an enhancement of 30× to ~35×) has been observed for on a cross-sectional monitor, with significant field enhancements happening in the vicinity of the nanoblocks. Moreover, these resonances can be easily moved along the frequency space based on the application of interest by changing the nanoblock dimensions.

For several practical purposes associated with specific applications such as in connection with developing modern nanophotonic platforms for multiplexing as used in molecular sensing and diagnosis, denser metasurface designs are important. A straightforward approach of packing more sensors on one platform is to decrease the device footprint of each sensor, which in this case can be achieved by decreasing the length of the device. It is no surprise, however, that the Q-factor plummets as the cavities in such experiments shrink from infinite to 5 um in length, for example from ~12,000 to ~600 for “Δd”=50 nm. This can be explained as follows: the resonance in such cavities takes a fano shape as shown above, which is a result of the interference between a broadband Fabry-Perot resonance (a “bright” mode) and a waveguide mode (a “dark” mode), The length of the device usually needs to be large enough to allow sufficient spatial overlap between the guided-mode and the Fabry-Perot mode to gain optimal Q-factors. Even though high-contrast gratings do a better job at confining modes to shorter characteristic distances than low-contrast gratings, decreasing the number of periods affects the flatness of bands near k=0, resulting in reduced Q-factors and increased mode leakage from the device ends.

In connection with the use of the nanoblocks in such VINPIX designs, as long as the frequency of the GMR lies within the mode-gap of the mirror segment, the segment will reflect the mode, in-plane, along the length of the device; however, the strength of this reflection will vary based on the mirror segment's band positions. According to other aspects of the present disclosure, the positions of the dielectric and air bands form the mode gap, and they are used in the calculation of the mid gap frequency for mirror segments of different lengths. Subsequently, the strength of each mirror segment is calculated with respect to confining the GMR using the formula:

$$\sqrt{{( {ω}_{2} - {ω}_{1} )}^{2} / {( {ω}_{2} + {ω}_{1} )}^{2} - {( {ω}_{res} - {ω}_{0} )}^{2} / {( {ω}_{0} )}^{2}}$$

where ω₂, ω₁, and ω₀ are respectively the frequencies for the air band edge, dielectric band edge, and midgap frequency of each mirror segment, and ωᵣₑₛ is the GMR frequency.

It has been observed with these experiments that the mirror strength almost saturates beyond 2.5 um of length and starts plummeting beyond 3 μm of segment length. Hence, a mirror segment of length 2.5 um is chosen as a stronger one of the mirrors (or the strongest mirror) and a segment of length 600 nm is chose as a weaker one of the mirrors (or the weakest mirror). Subsequently, 5 um long tapered mirror sections are appended on each end of the cavity, to form the pre-tapering or padding sections. The length of each mirror segment (“d”) is gradually incremriented to set an overall polynomial tapering of the form of X=AY^{P}+C, where X is the length of the mirror segment (“d”), Y is the position of the mirror segment from the cavity's end, P is the order of polynomial, and A and C are constants determined by the minimum and maximum mirror segment lengths of the tapered mirror section. In certain exemplary experiments, several different polynomial functions were tested ranging from p=0 (constant or no taper) to p=6. It was discovered that the highest mode confinement is achieved with a tapering of an order 4 polynomial for nanocavities without any perturbation, however, this fluctuates around 4 when the perturbation is introduced. The mode confinement was then analyzed in the vertical direction by taking Fourier transforms of the cross-sectional field profile and evaluating the amount of out-of-plane scattering. For a design in which the taper function is P=0 (i.e. all the mirror segments being 2.5 um in length (“d”)), the cross-sectional field profile of the x-component of the electric field and its corresponding FT spectrum demonstrates that a significant intensity exists inside the radiation zone, which indicates that a substantial radiation loss occurs in this design and the corresponding Q-factor for this device is merely ~1900.

In contrast, by using a design such as in FIG. 1 with a taper function of P=4, there is a massive drop in the intensity observed within the leaky region and correspondingly the Q-factor that was recorded for this design is greater than 600,000 Based on these experiments and according to the present disclosure, it is apparent that rational taper functions can accommodate optimal Gaussian-like field profiles inside and/or via the optical mirror devices, which subsequently minimizes the out of plane scattering and significantly enhances the mode confinement. Importantly, with appropriate tapering, padding sections and a cavity section including perturbation via interspersed nanoblocks, the optical mirror devices optimally reduce leakage and increase the Q factor.

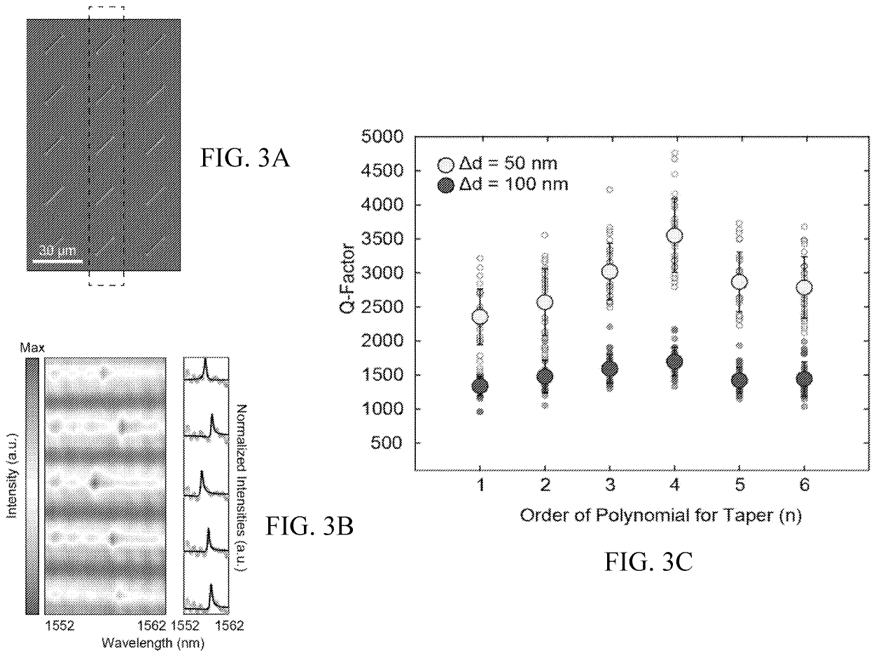

FIG. 3A-3C are also presented, according to certain exemplary aspects of the present disclosure and consistent with the type of VINPix described hereinabove in connection with FIG. 1 and other examples. FIG. 3A-3C generally demonstrates the experimental validation of the type of GMR pixel resonator design discussed above (e.g., with the three sections and including the perturbation dimensions of the nanoblocks in the cavity section). Employing a supercontinuum near-infrared light source and an imaging spectrometer, the metasurface is illuminate and the reflected intensity is captured, with the ability to individually address of each VINPix without relying on inter-device coupling. This enables significant improvement in packing densities (e.g., surpassing million resonators per cm²), enabling highly dense, compact, high-Q, free-space platforms. In connection with these disclosed experimental (non-limiting) example embodiments, remarkable Q-factors are achieved (e.g., approximately 4700 with Δd=50 nm and 2000 with Δd=100 nm), thereby validating the efficacy and high confinement of the GMR pixels used via such design types (and particularly with a fourth-order polynomial). With such highly-dense, high-performance free-space photonic platforms, the related advancements of these successful experiments demonstrates the usefulness of such structures (e.g., including GMR pixels on metasurface(s) as in FIGS. 1, etc.) for integrative and/or wearable and deployable platforms for multiplexed health and environmental monitoring, enhanced vibrational spectroscopy, wavefront shaping, and on-chip spectrometry.

More particularly, FIG. 3A is a SEM image (top-down view) of a substrate (e.g., the metasurfaces of FIG. 1), shown in a 3×5 array (fifteen VINPix as shown) of 15-μm-long VINPix with p=4 and Δd=50 nm. FIG. 3B shows a spectral image from five individual VINPix (left panel) and corresponding normalized row-averaged reflected intensities (right panel), and FIG. 3C shows experimentally-characterized Q-factors of different VINPix.

In FIG. 3B, the left panel is a spectral image from five individual VINPix as marked in FIG. 3A, and the right panel shows normalized row-averaged reflected intensities corresponding to each of the five VINPix. The highest intensity indication is at the top of the scale depicted in FIG. 3B.

FIG. 3C shows experimentally characterized Q-factors of 15-μm-long VINPix with 7-μm-long cavity sections of Δd=50 nm and 100 nm, and 4-μm-long tapered mirrors sections of different polynomial orders (P=1, P=2 . . . P=6). Average values and standard deviations correspond to 30 VINPix resonators measured for each set. The darker points (located along a lower horizontal plotting) correspond to the highest intensities and are associated with Δd=100 nm in FIG. 3C.

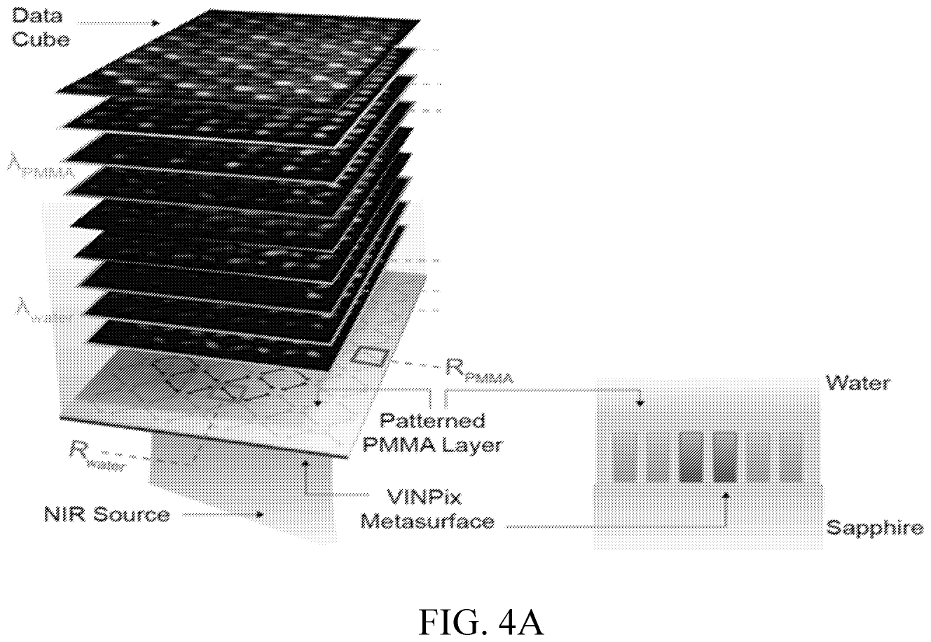

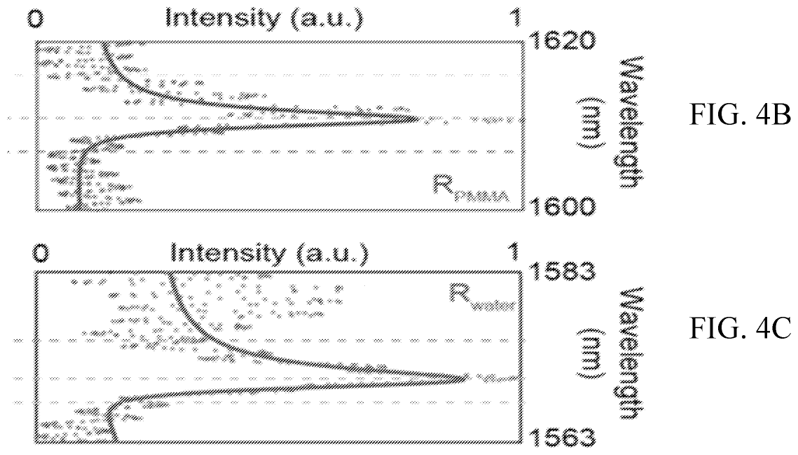

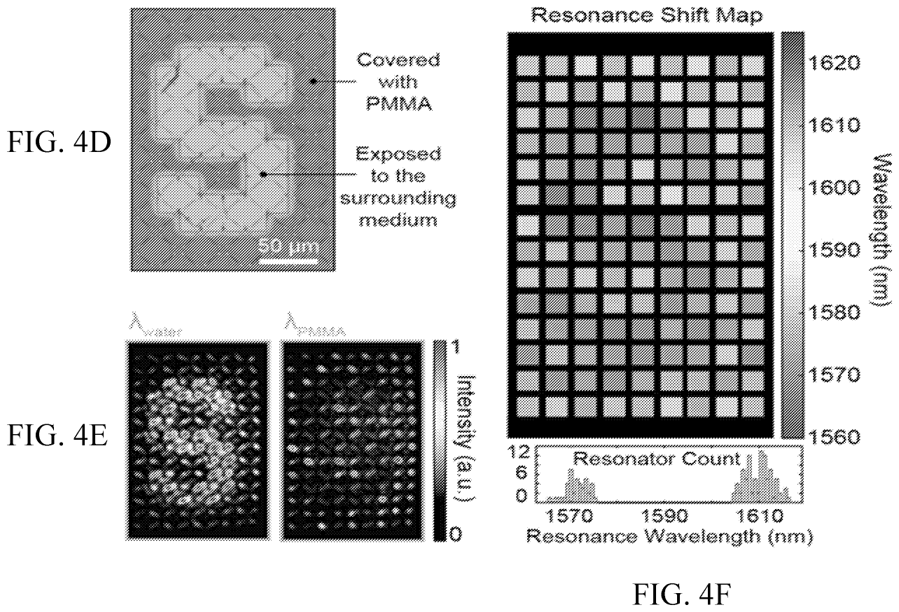

The depictions in FIGS. 4A-4F illustrate the application potential of such a densely fabricated GMR pixel metasurface, according to the present disclosure, in areas including a similar to high-density computational spectrometry and biosensing. Demonstrating such advancements, each resonator reports local refractive index changes through spectral resonance shifts, detectable via spatially-dependent intensity variations (e.g., shown using hyperspectral imaging to extract both spectral and spatial data from individual GMR pixel resonators, forming a comprehensive data cube). The metasurface is illuminated with a narrow-linewidth NIR tunable laser, sweeping across wavelengths from 1560 nm to 1620 nm. This technique allows for simultaneously imaging and the ability to collect spectra for hundreds of resonators in a single experiment (as depicted in FIG. 4E).

More particularly, FIG. 4A shows an optical system (similar to FIG. 1) for water and PMMA (Poly-methyl methacrylate) substances over the metasurface-based substrate and the VINPix-type device, and with an expanded view (lower right of FIG. 4A) of the patterned PMMA layer as the VINPix metasurfaces is covered by water and PMMA. FIGS. 4B and 4C show intensity-versus-wavelength plots, respectively, for PMMA and for water, as sensed by the system of FIG. 4A (which example includes a sapphire-based substrate), and FIGS. 4D and 4E show spectral responses respectively for pixel regions of the metasurface-based substrate being largely covered with PMMA as in FIG. 4D and as in the respective left and right panels of FIG. 4E with water and with PMMA (note: the top layer of 126 GMR pixels is patterned with PMMA resist in the shape of an “S”, differentiating the refractive indices of water (inside the “S”) and PMMA resist (outside the “S”), as shown in FIGS. 4C and 4D)).

FIG. 4F presents a spatially-resolved map of the resonance shifts across the entire field of view, along with a histogram representing the GMR wavelengths for all GMR pixel resonators recorded in the experimentation, and further presents the resonator count for resonance wavelengths associated with the water and the PMMA (note: the resonance wavelengths are shown detected at ~1570 nm for water and ~1610 nm for PMMA, thereby matching theoretical predictions according to the present disclosure and highlighting the precision of this type of design). Accordingly, this spatially-resolved mapping confirms the effective refractive index modulation by this type of the GMR pixel resonators and showcases their potential in precise, spatially-resolved sensing applications.

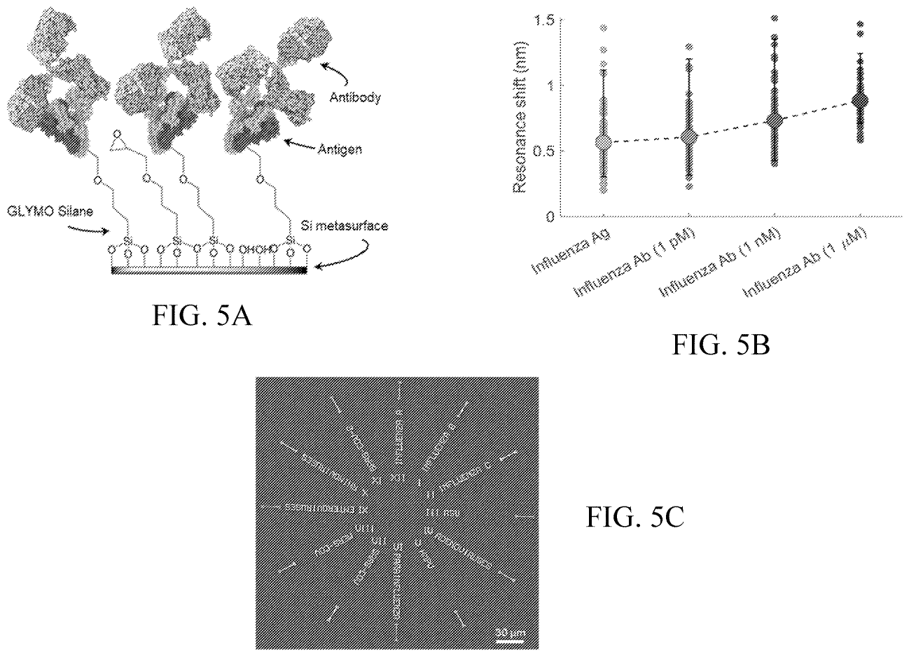

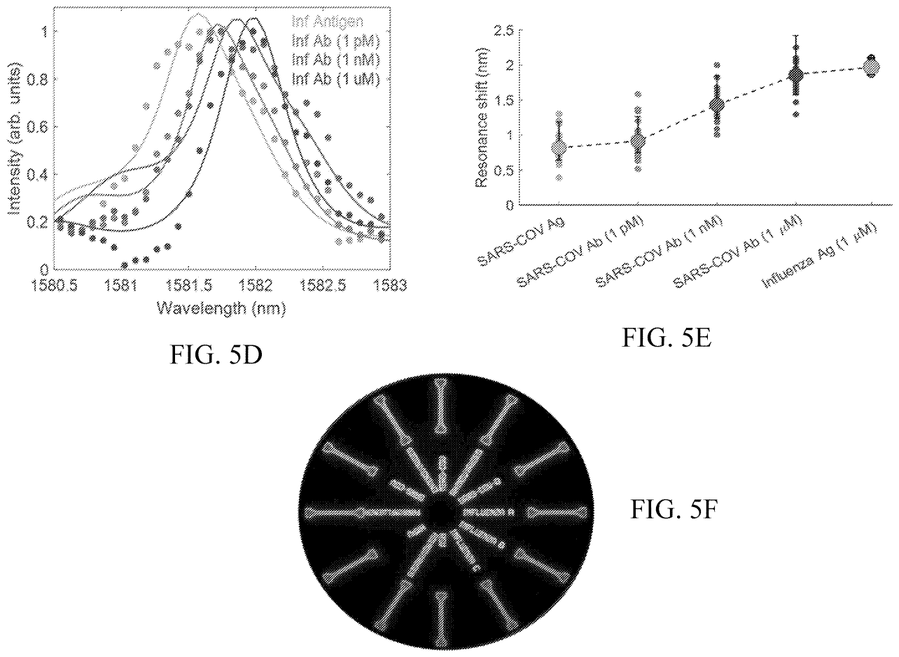

FIGS. 5A-5F illustrate experimental demonstration of the resonators as highly sensitive multiplexed biosensors. With the resonator devices being functionalized with self-assembled monolayers of an epoxy silane molecule GLYMO, attachment of antigens is enabled. Bioprinting can be combined with the dense arrays of resonator devices to pattern areas of devices with different antigens for highly multiplexed assays. In connection with such experimentation, attachment of antigens is demonstrated from both Influenza and SARS-CoV viruses and subsequent detection of associated Influenza and SARS-CoV antibodies.

More specifically, FIGS. 5A-5F illustrate multiplexed sensing of distinct antigens/antibodies using high-Q metasurfaces and bioprinting consistent with one or more sensing systems according to the present disclosure. More specifically, FIG. 5A shows an example in which a VINPix is functionalized on a Si metasurfaces using an epoxy (e.g., GLYMO) silane for binding, via bioprinting, an antigen specific to one of several antibodies, for example, for self-assembled monolayers that allow for controlled attachment and detection of proteins (enabling stable droplet printing of a variety of different protein types on different VINPix of the same array).

FIG. 5B is a graph showing resonance shift along the y axis and corresponding to functionalized VINPix (captured via a CCD sensor as in FIG. 1) for Influenza Ag and for Influenza Ab at three different concentrations (1 pM, 1 nM and 1 μM). Similarly, FIG. 5E is a graph showing plots of resonance shifting by wavelength (nm along y axis) corresponding to functionalized VINPix for sensing SARS-COV Ag, sensing three different concentrations of SARS-COV Ab (1 pM, 1 nM and 1 μM) and sensing Influenza Ag at a concentration of 1 μM. This example arrangement demonstrates one or many ways for how such an array of VINPix may be functionalized (e.g., via bioprinting) with different groupings and/or concentrations of antigens/antibodies.

FIG. 5D shows another set of intensity-versus-wavelength plots for each of the types of antibodies and/or concentrations depicted in FIG. 5B. If viewed in black and white, the mapping at the upper right of FIG. 5D, from top to bottom, corresponds to the plots as viewed at their peak intensities from left to right.

FIGS. 5C and 5F showing respective sets of antigens/antibodies for which the various VINPix were functionalized as discussed in connection with FIG. 5A. More specifically, FIGS. 5C and 5F are depicted as having different VINPix in an array functionalized accordingly, with different VINPix being designated for different groupings of antigens/antibodies (e.g., each VINPix of FIG. 5C and of FIG. 5F showing twelve different groupings and each specific to one type of antigen/antibody). Such functionalized sensor arrays exemplify how a highly miniaturized respiratory virus panel is configurable to detect the presence of many virus associated antigens/antibodies from a single sample on a single assay.

The bioprinting discussed in connection with one or more of the above examples, may be implemented as acoustic bioprinting. In certain implementations of acoustic bioprinting according the present disclosure, the methodology involves chemically or biologically functionalizing groupings of biosensors or individual resonators with unique surface functionalizations. Acoustic printing uses a focused high-frequency sound wave to eject droplets without a flow focusing nozzle. As such, the droplet diameter is a function of the acoustic transducer resonant frequency—the droplet diameter is inversely proportional to the resonant frequency or fᵣ. As examples, droplet diameters and corresponding fᵣ values may be: 500 microns and 5 MHz, 200 microns and 17 MHz, 100 microns and 45 MHz, and 25 microns and 147 MHz. As such, droplet volumes can be varied by varying the resonant frequency of the (droplet) printing function, with each sensor region capable of being functionalized to capture distinct biomarkers. In connection with the experiments in support of the present disclosure, successful capturing of distinct biomarkers has been demonstrated via stable biological printing with 4 resonant frequencies varying between 5 MHz and 147 MHz generating droplets between 300 um and 15 um in diameter or 4.5 nL to 2 pL in volume, respectively (as demonstrated in slide 1 of the attached slides). This printer is used to print and deposit an array of biological functionalizations onto integrated circuit chips (e.g., including the light source as depicted in the system figures herein). Varied surface chemistries may be used with the printer as there is no one exact functionalization scheme. As examples, localization of 2 pL droplets may be used by pattern printing of 2 proteins on to a silicon wafer, and this technique can be used to bind protein molecules onto resonators such as shown in connection with FIG. 1 and other examples. In a more specific example, the printer can be run using a 1 kHz ejection rate for 2 seconds to rapidly print 2000, 2 picoliter droplets onto an array of 100 biosensors. This generates a large droplet that totals 4 nanoliters of fluid. With this scheme, protein binding of 3 fluorescently-tagged proteins is realized through fluorescent measurements. This same method can be used to deposit antibodies onto an array of 100 resonators and measure the resonant frequency shift with the binding of this probe antibody along with a target protein (the receptor binding domain of the COVID spike protein) as was incubated on the chip. Shifts may be demonstrated across a single resonator along with the mean shift and standard deviation across 30 resonators. In other specific experimental examples, such a printer can be used to deposit 2 picoliter droplets onto single biosensor pixels, again using fluorescently tagged proteins. Such an approach may also be used for individual biosensor pixels involving multiplexed bimolecular detection, as such experimentation according to the present disclosure has demonstrated with successful deposition and binding of antibodies and other proteins onto individual biosensor pixels.

Accordingly, many different types of processes and structural/functional attributes and devices may be advantaged by one or more of the above aspects (and variations thereof readily apparent to the skilled artisan), including such aspects and examples disclosed by way of the above-identified U.S. Provisional Application including, for example, Appendix D of said U.S. Provisional Application for its discussion and illustrations involving examples of acoustic bioprinting.

It is recognized and appreciated that as specific examples, the above-characterized figures and discussion are provided to help illustrate certain aspects (and advantages in some instances) which may be used in the manufacture of such structures and devices. These structures and devices include the exemplary structures and devices described in connection with each of the figures as well as other devices, as each such described embodiment has one or more related aspects which may be modified and/or combined with the other such devices and examples as described hereinabove may also be found in the Appendices of the above-referenced Provisional Application.

The skilled artisan would also recognize various terminology as used in the present disclosure by way of their plain meaning. As examples, the Specification may describe and/or illustrates aspects useful for implementing the examples by way of various semiconductor materials/circuits which may be illustrated as or using terms such as layers, blocks, modules, device, system, and/or other circuit-type or material-type depictions. Also, in connection with such descriptions, various circuit elements and/or related circuitry may be used together with other materials and/or elements (e.g., optics elements such as mirrors, lenses, filters, windows, optical flats, prisms, polarizers, beamsplitters, wave plates, etc.) which may be used in combination, such as before or after such light is directed from the metasurfaces platform or substrate to the sensor, to exemplify variations of how certain examples may be carried out without necessarily departing from such above-disclosed examples of the present disclosure. It is also be appreciated that terms to exemplify orientation, such as upper/lower, left/right, top/bottom and above/below, may be used herein to refer to relative positions of elements as shown in the figures, and that the terminology is used for notational convenience only and that in actual use the disclosed structures may be oriented differently from the orientation shown in the figures.

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure, including aspects set forth in the claims.

1. An apparatus comprising:
a photonic mirror device including
opposing ends respectively characterized by first and second sets of one or more nanoblocks forming pre-tapering sections,
a cavity section including a plurality of differently-dimensioned interspersed nanoblocks having a length dimension d and a perturbation dimension Δd, and
first and second sets, each of three or more nanoblocks, situated between the opposing ends and the cavity section, to form respective tapered sections,
wherein the respective tapered sections and the cavity section are cooperatively arranged to support guided-mode resonance for a metasurface pixel (“GMR pixel”) by containing light and mitigating energy losses due to scattering of light, in response to light being directed towards an optical sensor via the GMR pixel.

2. The apparatus of claim 1, wherein the opposing ends respectively characterized by first and second sets of one or more nanoblocks forming pre-tapering sections are to mitigate photons scattering from the opposing ends, and the respective tapered sections have at least one side of decreasing block lengths in a direction towards the cavity section, characterized by X=AY^{P}+C, where X defines the block length from among the decreasing block lengths, A, Y, P and C represent respective positive numbers.

3. The apparatus of claim 1, wherein each of the respective tapered sections are characterized by decreasing block lengths of respective nanoblocks, from among the three or more nanoblocks, along a direction towards the cavity section.

4. The apparatus of claim 1, wherein the differently-dimensioned interspersed nanoblocks of the cavity section include at least five nanoblocks having the length dimension d and at least five nanoblocks having the perturbation dimension Δd.

5. The apparatus of claim 1, wherein the differently-dimensioned interspersed nanoblocks of the cavity section includes a plurality of nanoblocks having the length dimension d alternating in position with a plurality of nanoblocks having the perturbation dimension Δd.

6. The apparatus of claim 1, wherein each of the opposing ends, respectively characterized by first and second sets of one or more nanoblocks, includes a plurality of nanoblocks having a length dimension that is greater than any length dimension characterizing respective nanoblocks of the cavity section.

7. The apparatus of claim 1, wherein
each of a plurality of nanoblocks of each of the opposing ends has a common or similar length dimension that is not less than any length dimension characterizing any nanoblock in the cavity section and in the tapered sections,
each of the respective tapered sections are characterized by decreasing block lengths of respective nanoblocks, from among the three or more nanoblocks, along a direction towards the cavity section, and
certain nanoblocks of the interspersed nanoblocks of manifest a pattern corresponding to a length dimension d between two nanoblocks having perturbation dimension Δd, and with each of two nanoblocks of length dimension d is on either side of a nanoblock having perturbation dimension Δd without any intervening nanoblock.

8. The apparatus of claim 1, further comprising a high-Q molecular analysis system including a metasurface substrate to support a plurality of GMR pixels including the GMR pixel, wherein the nanoblocks of the respective tapering sections and the nanoblocks of the cavity section are designed with respective dimensions and spacings between the interspersed nanoblocks to maximize a Q factor associated with the cavity section.

9. The apparatus of claim 1, further comprising a high-Q molecular analysis system including a plurality from among the following: (a) a metasurface substrate to support the plurality of GMR pixels including the GMR pixel, wherein each of the plurality of GMR pixels is characterized according to the photonic mirror device; (b) a light source to direct the light for the guided-mode resonance; and (c) a CCD sensor as the optical sensor to capture the light being directed via the GMR pixel.

10. The apparatus of claim 1, further comprising a metasurface substrate to support a plurality of GMR pixels including the GMR pixel, each of the GMR pixels including the GMR pixel is a bio-functionalized pixel characterized by an attachment of distinct receptor or probe molecules to the GMR pixel.

11. The apparatus of claim 1, further comprising a metasurface substrate to support a plurality of GMR pixels including the GMR pixel, each of the GMR pixels including the GMR pixel is bio-functionalized by at least one of antigens and antibodies.

12. The apparatus of claim 1, further comprising:
a metasurface substrate to support a plurality of GMR pixels including the GMR pixel,
a CCD camera, and a light source to provide normally incident free-space near-infrared radiation, wherein each of the GMR pixels including the GMR pixel is a bio-functionalized pixel, and the nanoblocks of the respective tapering sections and of the cavity section and opposing ends are designed with respective dimensions and spacings between the interspersed nanoblocks to optimize a Q factor associated with the cavity section.

13. The apparatus of claim 1, wherein the cavity section is to support GMR at a certain Q factor level and to confine light and mitigation energy losses due to scattering of light, in response to light being directed towards the GMR pixel, wherein the light is to be confined with mitigation of energy losses via the tapered section characterized by a tapering slope corresponding to an order 4 polynomial function.

14. The apparatus of claim 1, wherein each of first and second sets of one or more nanoblocks includes three nanoblocks, with each of the three nanoblocks having a common or similar length dimension that is not less than a length dimension of any other nanoblock of the photonic mirror device.

15. A method comprising:
supporting guided-mode resonance for a metasurface pixel (“GMR pixel”) by operating a photonic mirror device to contain light and mitigate energy losses due to scattering of light, in response to light being directed towards an optical sensor via the GMR pixel, wherein the photonic mirror device includes
opposing ends respectively characterized by first and second sets of one or more nanoblocks forming pre-tapering sections,
a cavity section including a plurality of differently-dimensioned interspersed nanoblocks having a length dimension d and a perturbation dimension Δd, and
first and second sets, each of three or more nanoblocks, situated between the opposing ends and the cavity section, to form respective tapered sections,
wherein the respective tapered sections and the cavity section are cooperatively arranged to support guided-mode resonance for a metasurface pixel (“GMR pixel”) by containing light and mitigating energy losses due to scattering of light, in response to light being directed towards an optical sensor via the GMR pixel.

16. The method of claim 15, wherein the light is to be confined with mitigation of energy losses via the tapered section characterized by a tapering slope corresponding to an order 4 polynomial function.

17. The method of claim 15, further including using a metasurface substrate to support a plurality of GMR pixels including the GMR pixel, each of the GMR pixels including the GMR pixel is bio-functionalized by at least one of antigens and antibodies.

18. The method of claim 15, wherein the opposing ends respectively characterized by first and second sets of one or more nanoblocks forming pre-tapering sections are to mitigate photons scattering from the opposing ends, and the respective tapered sections have at least one side of decreasing block lengths in a direction towards the cavity section, characterized by X=AY^{P}+C, where X defines the block length from among the decreasing block lengths, A, Y and C represent respective positive numbers, and P represents a positive number greater than two.

19. The method of claim 15, wherein the interspersed nanoblocks of the cavity section are alternating in that nanoblocks of the length dimension d appear in at each second position at which one of the nanoblocks of the cavity section is situated.

20. A method according to claim 15, wherein the respective tapered sections and the cavity section are cooperatively arranged to support guided-mode resonance with a corresponding Q factor of over 100,000.

21. (canceled)
